(19) United States
(12) Patent Application Publication
(10) Pub. No.: US 2004/0044648 A1
(43) Pub. Date: Mar. 4, 2004

(54) Method for data-centric collaboration

(75) Inventors: Ole Jorgen Anfindsen, Enebakk (NO); Stian Bakken, Oslo (NO); Knut-Olav Traa, Oslo (NO); Ann Gro Sommerhein, Oslo (NO); Rune Storlopa, Oslo (NO); Bjorn Borgen, Oslo (NO); Per Anfindsen, Oslo (NO)

Correspondence Address: OBLON, SPIVAK, MCCLELLAND, MAIER & NEUSTADT, P.C., 1940 DUKE STREET, ALEXANDRIA, VA, 22314, US

(73) Assignee: XMYPHONIC SYSTEM AS, Kjeller (NO)

(21) Appl. No.: 10/601,697

(22) Filed: Jun. 24, 2003

Related U.S. Application Data
(60) Provisional application No. 60/390,367, filed on Jun. 24, 2002.

(51) Int. Cl. G06F 17/30; G06F 7/00

(52) U.S. Cl. 707/1; 715/500

(57) ABSTRACT

A method, system, and collaborative user interface for creating a collaborative environment for users to work on shared resources on a computer network. Each resource is capable of being subdivided into sub-resources in a hierarchical manner, and each sub-resource is treated in a transactional way in the sphere of control to which it is delegated/copied, which ensures proper treatment with respect to the resource from which it originated. The method thus provides a powerful management system allowing a number of people to work simultaneously on various parts of the shared resources.

### CROSS-REFERENCE TO RELATED APPLICATIONS

The present application claims priority to the earlier filing date of provisional U.S. application Ser. No. 60/390,367, filed Jun. 24, 2002, the entire contents of which are incorporated herein by reference.

### BACKGROUND OF THE INVENTION

1. Field of the Invention

The present invention relates to a method for collaboration between users of computer systems in a computer network, wherein the users collaborate by accessing and modifying shared data resources, objects or documents. In particular, the invention relates to a method, a computer system and computer program products for client side handling of shared data resources.

2. Discussion of the Background

Collaboration between people is important in any civilized society. The lack of proper support for collaboration in today's computing infrastructure is undoubtedly one of its most profound shortcomings. Data-centric collaboration is characterized by two or more people working concurrently on a shared pool of data resources. Moreover, such work may not be considered collaborative, unless the people involved are working towards a common goal. An example of data-centric collaboration would be a group of people working simultaneously on a large document. Other examples would be a group of engineers working together on the design of, for example, an automobile, an airplane, or a ship.

The challenges of data-centric collaboration occur whenever two or more users need to work with the same data objects during an extended period of time (anything from minutes to months). The classical textbook example is that of designers or engineers using a CAD/CAM tool. On the one hand, they need access; both read and write access in the general case, to each other's portions of the data. On the other hand, they need control over their data. And there is an inherent conflict between concurrent access and control.

Thus, when performing data-centric collaboration, one must have some sort of concurrency control, or else one will experience so-called anomalies like, e.g., lost updates or conflicting updates. But if the control is too strict, people will be prevented from doing what they have to do. This is the dilemma facing anyone who wants to take on the challenges of collaborative work, and to design a good user interface.

A number of basic techniques are available for providing control in collaborative projects. In a lock-based system, if one person is working with a data resource, that resource is marked by the system as locked as long as that person is working with the resource. Locking systems can have different degrees of sophistication, but most will at least distinguish between read and write locks. Most transactional systems use some form of locks, but the use of locks does not necessarily cause a system to be transactional.

When a user attempts to access a locked document, the user interface, e.g., in a word processing application, will typically respond with a message that informs the user that the document is in use, and that the user can only open a read-only copy of the document. Microsoft Corporation's Netmeeting® is a type of collaboration software that allows users to take turns at controlling applications to work with documents and files.

A versioning system will allow a data resource to exist in multiple versions. If the system allows a sequence of versions (e.g., 1, 2, 3, . . . ) for a resource, these are known as revisions. If the system allows branching to take place, i.e., the system allows multiple versions to be derived from one particular version, then such multiple versions are known as variants. Variants may have to be merged (i.e., combined) later, to form a new version containing the changes from the different variants. Versioning is attractive for some application domains, e.g., where it is important to keep track of the history of resources.

However, versioning is a poor mechanism for supporting concurrent collaborative work. This is so because of the problems related to merging the variants that result from such work. No general algorithm for merging exists (i.e., the merging process can only be automated in special cases), so human involvement in the merge process is often used, and there is little or no support from the user interface.

IBM's Lotus Notes® handles versioning such that if two persons have amended the same document, both variants will show up with a mark indicating a conflict that must be manually resolved. Another system for collaboration is described in international patent application PCT/US00/17785 (WO 0106365), wherein the user interface is based on the concept of a shared space that is synchronized when users go on-line.

In a check-out/check-in system, a data resource is checked out before a person can start working on it, and the resource is checked in when the work is completed. While a resource is checked out, it is marked as such, i.e., it is essentially locked by a check-out lock. However, checking out a resource not only involves locking it, but also creates a separate copy of the resource; it is this copy of the resource that can be worked on. During check-in, the original version of the resource is replaced by the modified version.

It should be noted that no more than one person can check out a given resource at a time. It should also be noted that if someone tries to read a checked-out resource, he or she will get access to the original version of the resource, not the separate copy currently being worked on by the person who performed the check-out operation. Thus, check-out/check-in is actually a combination of very simple locking and very simple versioning. This simplicity is probably its main virtue, and it is successfully used in many real-world applications.

The above techniques may be complemented by less basic techniques, e.g., a good user interface that makes it as easy as possible for users to exploit the available functionality. Accordingly, there are many proprietary solutions that work quite well for certain application domains. For example, Microsoft Corporation's WORD allows annotations and/or change proposals to be inserted into a document, thus creating a new version of that document. Such a version can then be merged with the original version, allowing the person in charge to accept or reject the various change proposals. Because of the nice user interface, this collaboration works well as long as no more than two people are involved. As the number of people involved grows, this style of collaboration gets more and more unwieldy; it simply does not scale well.

The known techniques described above may work well within limited areas or application domains, but suffer from a number of limitations and shortcomings. Among the most important shortcomings are sharing of information between collaborators, meta information regarding the shared resources and the status of work being performed on them, flexible division and distribution of tasks and responsibilities and dynamic delegation/assignment of such tasks and responsibilities.

### SUMMARY OF THE INVENTION

The present invention provides more powerful and flexible mechanisms for accessing and changing shared resources in a collaborative manner. Such resources may reside on one or more servers, preferably handled by a suitable database management system, but in principle the resources and the management system may exists in a distributed fashion on a computer network, utilizing peer-to-peer mechanisms and other tools for administering the collaborative work.

For example, related U.S. Pat. No. 5,983,225 (hereinafter “the '225 patent”) describes a database management system (DBMS) that is modified to provide improved concurrent usage of database objects, particularly when the system is executing long-lived transactions. The '225 patent's DBMS provides a resource lock management system providing a lock data structure storing lock data representing granted and pending resource lock requests, and a lock manager for evaluating granting and denying resource lock requests. The '225 system may be used in conjunction with the present invention. Accordingly, the entire contents of the '225 patent are incorporated herein by reference.

Further, related U.S. Pat. No. 6,044,370 (hereinafter “the '370 patent”) describes a DBMS implementing a data processing method for storing information in which a subset of the stored information comprises annotated values, and for processing the stored information. Each annotated value has a stored data value and an associated data reliability value. The processing of the stored information includes: (1) combining annotated values, (2) comparing annotated values, and (3) combining annotated truth values in accordance with a predefined set of rules to preserve relevant data reliability values associated with the annotated values and the annotated truth values. The '370 system may be used in conjunction with the present invention. Accordingly, the entire contents of the '370 patent are incorporated herein by reference.

In addition, a method and system for processing and managing requests for concurrent use of data, which may be used in conjunction with the present invention, is described in co-pending U.S. patent application Ser. No. 09/194,784 (hereinafter “the '784 application”), the entire contents of which are incorporated herein by reference. In the '784 application, nested databases are utilized in order to create different environments in which the data can be accessed and modified. For each transaction in existence, there is an indication or reference to a database or sub-database associated with that transaction. There are also data structures that indicate, for each data item at issue, the database or sub-database associated with that data item. The use of data structures relating the transactions, sub-databases, and data items allows the creation of spheres of control for the various transactions and sub-databases. Thus, data can be readily shared among a plurality of users in a virtual space or sphere of control. Moreover, the creation of the sub-databases does not require plural copies of the data, and the database management system may be implemented using only one copy of the data, although multiple copies may be utilized, if desired.

An object of the present invention is to provide a client-based collaboration method configured to access and work on resources managed by a DBMS system that incorporates the collaboration solutions described in the above-noted patents and applications. However, the present invention is not limited to operating only in conjunction with those DBMS systems.

According to one aspect of the present invention, there is provided a client-computer based method for establishing a shared resource, defining tasks and responsibilities, delegating tasks and responsibilities, and committing the results of the tasks performed by various people collaborating on the resource in order to create a completed result of the collaborative work.

One feature of the present invention is the creation of a hierarchical structure of locks on the various elements of the shared resource in accordance with the manner in which various tasks and responsibilities are distributed and delegated. Further, the hierarchical structure of the locks is dynamic in a way that allows redistribution and sub-delegation of tasks and responsibilities. Access rights may be handled in a similar manner.

The present invention also provides a method for structuring and presenting information related to the status of the various elements of the shared resource.

According to one aspect of the present invention, there is provided a method and computer program product for managing a collaborative work environment wherein plural users share data resources, comprising: (1) accessing or creating a first data resource assigned to a first hierarchical level, said first data resource having at least one subdivision; (2) creating at least one sub-resource corresponding to said at least one subdivision of said first data resource, and associating each sub-resource with at least one additional hierarchical level; and (3) creating a data structure indicating that each data resource on a hierarchical level is a transaction associated with a subdivision of a related data resource on a prior hierarchical level, and that each subdivision is locked until the associated transaction is committed.

The above-mentioned method and computer program product further includes (1) associating each data resource or sub-resource with a corresponding user of the plural users in the collaborative work environment; (2) associating at least one access parameter with each data resource or sub-resource; and (3) storing the data resources and said data structure in a remote database server that includes a database or nested databases, or storing the data resources and said data structure in a distributed manner in a data network.

According to another aspect of the present invention, there is provided a method and computer program product for accessing, from a client computer, a shared data resource in an environment for collaborative work, comprising retrieving a data structure stored on a computer network, said data structure representing said data resource and sub-resources associated with at least one sub-division of said data resource, the sub-resources being associated with at least one hierarchical level, each data resource on a hierarchical level being a transaction associated with a subdivision of a data resource on a prior hierarchical level, and each subdivision being locked until all associated transactions are committed.

According to still another aspect of the present invention, there is provided a system for managing a collaborative work environment in which plural users share at least one data resource, comprising: (1) plural client computers, each client computer having a collaborative user interface configured to allow a respective user to access or create a first data resource assigned to a first hierarchical level, the first data resource having at least one subdivision; and (2) at least one server computer communicatively coupled to the plural client computers over a network, the at least one server computer having a database management system configured to create at least one sub-resource corresponding to the at least one subdivision of the first data resource, and associating each sub-resource with at least one additional hierarchical level, wherein the database management system is configured to create a data structure indicating that each data resource on a hierarchical level is a transaction associated with a subdivision of a related data resource on a prior hierarchical level, and that each subdivision is locked until the associated transaction is committed.

According to another aspect of the present invention, there is provided a collaborative user interface configured to coordinate collaborative work over a network by plural users, comprising: (1) a first interface unit configured to allow a user to establish a sphere of control in which at least one authorized sub-user has access to at least one respective sub-resource selected from plural data resources stored in a database; (2) a second interface unit configured to allow the user to accept or discard work performed on the at least one sub-resource by each of the at least one authorized sub-user; and (3) a third interface unit configured to display a hierarchical representation of the sphere of control, including a status of the sub-resources associated with each sub-user.

Further, according to the present invention, the first interface unit of the collaborative user interface is configured to (1) allow the user to determine the at least one authorized sub-user and to invite the at least one authorized sub-user to participate in the sphere of control; (2) allow the user to determine the sub-resources accessible to each sub-user in the sphere of control; (3) prevent the user from allocating greater access rights over the at least one sub-resource, to the at least one authorized sub-user, than the access rights held by the user; (4) allow each of the at least one authorized sub-user to set an access parameter for an associated sub-resource in the sphere of control, the access parameter indicating a status of the associated sub-resource; (5) designate a sub-resource accessible to a sub-user as read-only to the user until the work performed by the sub-user on the sub-resource is accepted or discarded by the user; and (6) restore to the user original access rights to the sub-resource after the work performed by the sub-user on the sub-resource is accepted or discarded by the user.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a network of server computers and client computers creating an environment for collaborating on shared resources in accordance with the invention;

FIG. 2 is a schematic of a computer system used as a server computer or a client computer in accordance with an example embodiment of the present invention;

FIGS. 3-15 illustrate multiple views of the display of client computers operating in accordance with the invention;

FIGS. 16-23 illustrate multiple views of the display of client computers operating in accordance with the invention but without reference to word processing or any other particular application;

FIG. 24 illustrates the steps in a preferred method for managing a collaborative work environment according to the present invention;

FIG. 25 illustrates the steps in a preferred method for accessing, from a client computer, a shared data resource in an environment for collaborative work according to the present invention; and

FIG. 26 illustrates a collaborative user interface configured to coordinate collaborative work over a network according to the present invention.

### DESCRIPTION OF THE PREFERRED EMBODIMENTS

The challenges of data-centric collaboration show up whenever two or more users need to work with the same data objects during an extended period of time (anything from minutes to months). The classical textbook example is that of designers or engineers using a CAD/CAM tool. On the one hand, they need access: both read and write access in the general case, to each other's portions of the data. On the other hand, they need control over their data. And there is an inherent conflict between concurrent access and control.

Thus, when performing data-centric collaboration, some sort of concurrency control should be utilized, or else one will experience so-called anomalies, e.g., lost updates or conflicting updates. On the other hand, if there is too much control, people will be prevented from doing what they have to do. This is the dilemma facing anyone who wants to take on the challenges of collaborative work.

People who collaborate usually also need to communicate. If people are co-workers in an environment utilizing the method according to the invention, they will need to look at other people's contributions every now and then. The invention makes it very easy to share information, provided the involved parties agree that it should happen.

First, it is easy to set up a sphere of control containing the shared resources such that all participants see the contributions of others as work is progressing. Even so, each participant is working on a local copy of the data on his or her client machine, and can control how often work should be shared with others in the same sphere of control.

Second, unless it has been disallowed by the creator of the sphere of control or the system administrator, a participant can choose to place exclusive locks on his or her work, preventing all others from looking at it until it is committed to the shared environment. It should be noted that the shared environment can be configured in such a way that no participant can commit work without the approval of the owner or a deputy.

Third, the present invention allows a schema to be created with an arbitrary number of access parameters. By associating access parameters with data objects, writers can inform potential readers of the quality, maturity, reliability, or degree of completeness of their work. Some simple examples of such parameters include:

Incomplete draft,

Complete draft, and

Approved draft.

More complicated parameter sets may be created, of course. Not only can the number of parameters be increased, one can also come up with different groups of parameters, related to different aspects of the work. For example, there can be multiple parameters for each of the following aspects:

Managerial,

Legal,

Financial,

Technical,

Marketing,

Security related, and

Policy related.

The kind of information one might want to represent for each of the above, could be pending approvals, compliance with corporate policy, quality assurance, etc. Default schemas could be created for particular industries, and further elaborations can be added for individual companies, departments, and projects. Some companies would be happy to use the default schema supplied with a product operating according to the invention upon installation, others would want to take advantage of customization facilities.

As described above, writers use access parameters as a means of communicating the current status of their data to potential readers. However, readers also use access parameters as a means of selecting which data resources to read. Access parameters associated with a read request inform the system of the reader's willingness to read data with a certain quality, reliability, maturity, or degree of completeness. Thus, it is possible, e.g., to scan for all documents that have reached the level of complete draft, or all documents that are currently being worked on by the legal department, etc. More advanced queries are also possible, as described below.

Access parameters are precisely what enable the system of the present invention to support conditional compatibility between readers and writers. The default compatibility test is quite straightforward: a writer and a reader are compatible if and only if write parameters make up a subset of read parameters. Other conditions for compatibility may be implemented, but the default “subset relation” covers most of the interesting application requirements.

It is easy to implement support for conditional compatibility between readers and writers. If parameters are represented by bitmaps, it is only necessary to perform bit-wise AND and OR operations on those bitmaps. Although supporting dirty reads, wherein anyone can read anything at anytime, including uncommitted changes to the shared environment, is not difficult, as demonstrated by prior approaches, some drawbacks do exist with dirty reads. For example, readers have no control over what kind of data they get. In other words, they cannot be selective with respect to the status of the data they read. Further, readers have, in the general case, no way of telling whether a given data item contains committed, stable, and therefore trustworthy information, or something entirely different. In other words, readers are left in the dark as to the status of data they retrieve.

Thus, one could say that dirty read is a do-it-yourself approach to sharing information between readers and writers. However, it should be noted that that the dirty read approach presents no advantages to coordinating multiple writers. It is important to have information about the state of the entire system at the time of the query, otherwise dirty reads will obviously be quite unsatisfactory, and could potentially lead to serious consequences. Thus, it is well known that dirty reads are inadequate in many circumstances, sometimes even counterproductive. In contrast, access parameters, as defined according to the present invention, bring discipline and predictability to the way readers and writers interact.

A system operating according to the present invention may have a mechanism for determining which users are allowed to use which portions of the parameter domain, so that another interesting possibility emerges. Such a mechanism gives writers a simple tool for selectively sharing their data with some users, but not with others. In other words, access parameters can provide a dynamic and fine-grained tool for access control, complementing access control mechanisms at the level of, e.g., operating system, application, database, and the sphere of control (the shared environment).

In their simplest form, read parameters simply cause the system to skip data items that have incompatible write parameters. But this means that the lock manager component acts as an extension of the query mechanism. According to the present invention, this concept is taken one step further by allowing queries to express conditions related to access parameters. By adding at least one truth-valued function to the query language, complicated queries are supported. Here are two examples of the kind of queries that are possible:

retrieve all design elements that have been approved by the project manager, but where approval from the marketing department is pending.

retrieve all documents for which the legal department's approval is pending, and that are currently being worked on either by engineers or designers.

In addition, it is possible to create a single, unified framework for dealing with the following kinds of problems: (1) information is currently unreliable (i.e., subject to change) because someone is working on the data in question; (2) information is unreliable, perhaps permanently so, because the values stored in the system are based on less-than-perfect input (for various reasons); and (3) information is missing for various reasons.

A technical framework for implementation of the present invention is described in Chapter 7 of Anfindsen, O J. 1997. Apotram—an application-oriented transaction model. Ph.D. Thesis, Department of Informatics, University of Oslo, Norway. Research Report 215, the entire contents of which are incorporated herein by reference. That reference includes a generalized version of Boolean algebra, capable of dealing with predicate evaluations in the presence of missing and unreliable information.

A description of a collaborative environment operating according to the present invention will now be given. In addition, examples illustrate how collaboration in accordance with the present invention can be used in practice. It should be noted that while the examples discussed below are simple and involve few users, the illustrated concepts are valid even if the numbers of people, spheres of control, and data resources were much higher, and even if the application domain were much more complicated than simple editing of text documents. An example of a complex application domain that requires better support for collaboration is CAD/CAM.

The present invention will be better understood in light of the following description of a preferred embodiment, with reference to the drawings. It should be noted, however, that the preferred embodiment described herein is an example only and is not intended to limit the scope of the invention defined in the appended claims.

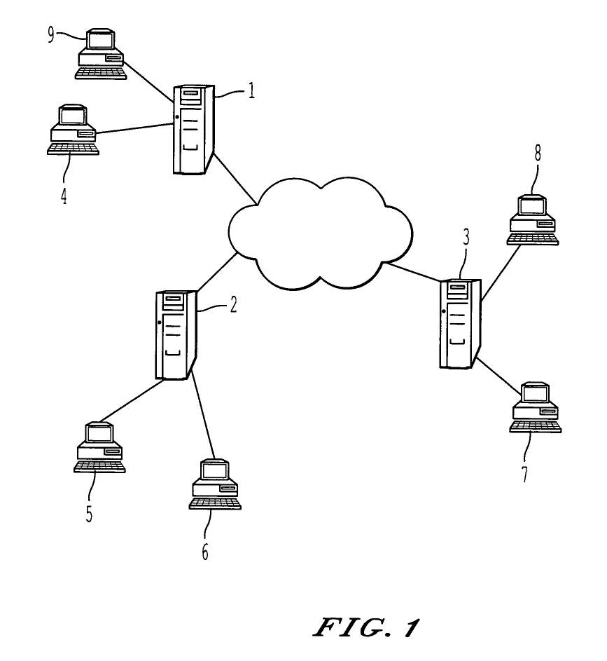

Reference is made to FIG. 1, which shows a network of client and server computers. A first server 1 is located in a first location, a second server 2 is located in a second location, and a third server 3 is located in a third location. A number of client computers 4, 5, 6, 7, and 8 are connected to each server through respective local area networks (LAN), while the respective servers are interconnected through a wide area network (WAN), such as the Internet. Preferably the various client computers may also communicate using the wide area network in order to communicate with servers or client computers in other locations.

The server computers 1, 2, and 3 according to a preferred embodiment comprise databases with database management systems capable of handling shared resources and registering features associated with the various resources as these are created and changed from the client computers. However, an alternative embodiment of the invention may relocate some or all of the functionality of the servers to the client computers in a distributed manner and, e.g., utilize peer-to-peer access to the shared resources.

FIG. 24 illustrates a method for managing a collaborative work environment according to the present invention, wherein plural users share data resources.

In step 31, a first data resource assigned to a first hierarchical level is accessed or created, wherein the first data resource has at least one subdivision.

Next, in step 32, at least one sub-resource corresponding to the at least one subdivision of said first data resource is created and each sub-resource is associated with at least one additional hierarchical level. Each data resource or sub-resource is an electronic document, a computer file, a set of computer files, or a computer resource that can be accessed, copied, and modified from a client computer shown in FIG. 1.

In step 33, each data resource or sub-resource is associated with a corresponding user in the collaborative work environment.

In step 34, at least one access parameter is associated with each data resource or sub-resource. As discussed below, an access parameter may represent work status, approval status, ownership, whether the data resource or the sub-resource is locked, and by which transaction the data resource or sub-resource is locked.

In step 35, a data structure is created indicating that each data resource on a hierarchical level is a transaction associated with a subdivision of a related data resource on a prior hierarchical level, and that each subdivision is locked until the associated transaction is committed.

Finally, in step 36, the data resources and said data structure are stored in a remote database server that includes a database or nested databases. Alternatively, the data resources and the data structure are stored in a distributed manner in the data network shown in FIG. 1.

Note that a selected sub-resource corresponding to a further sub-division of an existing sub-resource may be created and assigned by creating a copy of said sub-division. The sub-division is then associated with a selected user in the collaborative work environment, and a lock is placed on the sub-division of the existing sub-resource until the assigned sub-resource is committed, approved, and included in the original sub-resource.

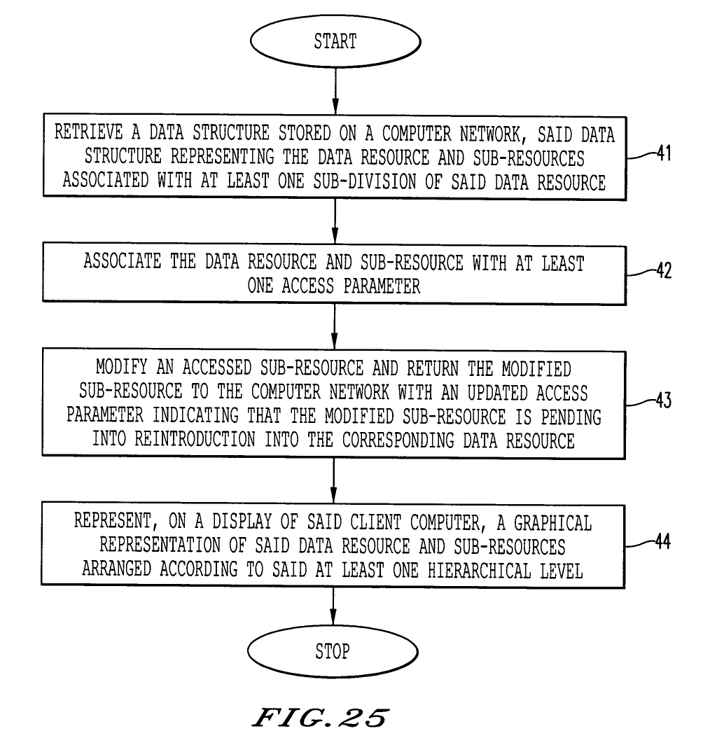

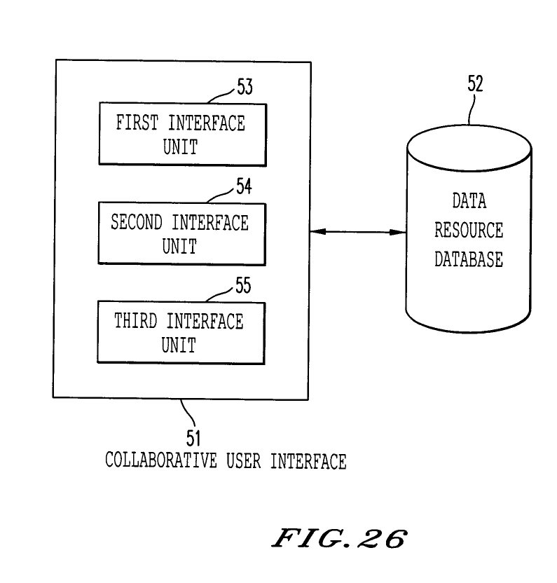

FIG. 25 illustrates a method for accessing, from a client computer, a shared data resource in an environment for collaborative work.

In step 41, a data structure stored on a computer network and representing the data resource and sub-resources associated with at least one sub-division of the data resource is retrieved. Note that the sub-resources are associated with at least one hierarchical level, each data resource on a hierarchical level being a transaction associated with a subdivision of a data resource on a prior hierarchical level, and each subdivision being locked until all associated transactions are committed. Each data resource or sub-resource is an electronic document, a computer file, a set of computer files, or a computer resource that can be accessed, copied, and modified from a client computer. Moreover, the data resource and the data structure are stored in a remote database server having a database or nested databases. Alternatively, the data resource and the data structure are stored in a distributed manner in a data network.

In step 42, the data resource and the sub-resources are associated with at least one access parameter. That is, the data structure includes access parameters indicating at least one of work status, approval status, ownership, whether the data resource is locked, and by which transaction the data resource is locked.

In step 43, an accessed sub-resource is modified and returned to the computer network with an updated access parameter indicating that the modified sub-resource is pending reintroduction into the corresponding data resource. Note that the data structure may be modified, as a result of a request, to only include representations of resources and sub-resources that fulfill a set of conditions regarding access parameters associated with each resource and sub-resource.

Finally, in step 44, a graphical representation of the data resource and sub-resources arranged according to the at least one hierarchical level are represented on a display of a client computer shown in FIG. 1.

FIG. 26 illustrates a collaborative user interface 51 configured to coordinate collaborative work over a network by plural users, according to the present invention. The collaborative user interface 51 includes a first interface unit 53 configured to allow a user to establish a sphere of control in which at least one authorized sub-user has access to at least one respective sub-resource selected from plural data resources stored in a data resource database 52. The first interface unit 53 configured to allow the user to determine the at least one authorized sub-user and to invite the at least one authorized sub-user to participate in the sphere of control. Further, the first interface unit 53 is configured to allow the user to (1) determine the sub-resources accessible to each sub-user in the sphere of control; (2) prevent the user from allocating greater access rights over the at least one sub-resource, to the at least one authorized sub-user, than the access rights held by the user; and (3) allow each of the at least one authorized sub-user to set an access parameter for an associated sub-resource in the sphere of control, the access parameter indicating a status of the associated sub-resource. Moreover the first interface unit 53 is configured to designate a sub-resource accessible to a sub-user as read-only to the user until the work performed by the sub-user on the sub-resource is accepted or discarded by the user, and to restore to the user original access rights to the sub-resource after the work performed by the sub-user on the sub-resource is accepted or discarded by the user.

The collaborative user interface 51 also includes a second interface unit 54 configured to allow the user to accept or discard work performed on the at least one sub-resource by each of the at least one authorized sub-user.

Finally, the collaborative user interface 51 includes a third interface unit 55 configured to display a hierarchical representation of the sphere of control, including a status of the sub-resources associated with each sub-user.

To illustrate the system and method of the present invention with an example, reference is made to FIG. 1, wherein the reference numerals will refer to locations or servers, and users or their client computers, respectively. In the example, a company is getting ready to bid for a major contract. Based on specifications from the potential customer, the contents of the bid document are quickly outlined. Alice is the appointed editor and project manager, and she therefore has the responsibility of ensuring that the bid document is ready on time.

The company has offices in Boston 1, Oslo 2, and Bangalore 3, and contributions are needed from people at each of these offices. Alice creates a skeleton document on her client computer 4, with preliminary headers for some of the chapters and sub-chapters. She then uses a utility function in her collaboration tool, which has been integrated with her word processor, to automatically or manually split the document into a suitable number of sub-documents. Next, she creates three spheres of control, one for each of the branch offices 2 and 3. In this process, she is prompted to specify which sub-documents to delegate to each sphere of control, and who to invite as participants in each sphere.

From her client computer 1, Alice creates one sphere of control for each branch office in Boston 1, Oslo 2, and Bangalore 3. It should be noted that a collaboration system according to the present invention will allow spheres of control to be distributed. Alice is located in Boston. Her local server 1 will thus be controlling the entire collaborative project that Alice is in charge of, but the spheres of control that she created for her colleagues in Bangalore and Oslo, respectively, need not reside on that same server 1. Preferably, once a sphere of control is created, it is checked out to another server, and the system ensures that sooner or later the sphere of control is checked back in, The latter actually means either committing or aborting the sphere of control, because a given sphere of control is in fact a transaction, albeit a passive transaction.

There are some obvious advantages to the model's flexibility with respect to distribution. One is that the server where the collaborative project originates is eliminated as a single point of failure. That is, even if the server in Boston is down for a while, the spheres of control in Oslo and Bangalore can continue without interruption, since their respective spheres of control are located on the local servers 2 and 3. Once automatic recovery has been carried out in Boston, the server 1 will be ready to receive the results from Oslo and Bangalore when those spheres of control are ready to be committed. In fact, the teams in Oslo and Bangalore may never realize the server in Boston was down at all.

A second advantage is better response times because people can work locally. Rather than having to communicate with a server over a global network, collaborators can enjoy working in the controlled environment of a local area network, which usually provides larger bandwidth. Only when a sphere of control is created, committed, or aborted, when information is exchanged between spheres of control, or when new resources are added to a sphere of control is there a need for communication between the various geographical sites.

Yet another advantage, which follows from the above design, is that the present invention facilitates load balancing between multiple servers by allowing spheres of control to be created and distributed as needed.

Co-workers in a sphere of control are of course able to share information among themselves. There are two basic methods of doing this. One solution is to simply let everyone see all data resources at any time. Another solution is to use access parameters to limit who gets access to data at a given point in time.

It should be noted that each collaborator can control when his/her contributions are made available in the sphere of control. In such within-sphere publishing, data resources are copied from the client machine to the server. This can be done manually or automatically.

Consider, for example, Arne 5 and Berit 6 working in the Oslo environment 2. Let us assume Arne 5 has some documents marked with the parameter “complete draft,” and some others marked with “incomplete draft.” If Berit 6 prefers to read only documents that are complete draft or better, or, alternatively, the sphere of control is configured such that she is not allowed to see incomplete drafts, an attempt from Berit to read Arne's documents will give access only to some of those documents.

This feature of the present invention is relevant to complicated applications that deal with a large number of objects in each sphere of control. For example, the leader of a design project who wishes to assess the progress of his/her team may want to run a query over the contents of a sphere of control, filtering away all immature design structures.

The present invention also allows people working in different spheres of control to share information with each other. There are multiple ways in which a system implementing the present invention could be configured to support this kind of interaction among spheres of control. A simple approach is to specify, for each sphere of control, which data resources to export and which data resources to import. The resources can only be exported/imported in read-only mode. That is, even if a data resource is exported, it can still be edited in the sphere of control from which it has been exported, and when a data resource is imported it is prevented from being edited in the sphere of control to which it has been imported. Thus, at a given point in time, there will be a single sphere of control in which a particular data resource can be edited.

There are several ways in which the simplistic scheme outlined above could be enhanced. Rather than a sphere of control simply making resources available in read-only mode to other spheres of control by exporting them, one could export resources to specific spheres only. The spheres of control to which one would like to export could be named on an individual basis, or according to some more generic specification, e.g., related to the hierarchical structure of spheres of control.

Returning to our example, consider Anjali 7 and Bansi 8 working in Bangalore 3. Anjali 7 decides that she wants to share some of her documents with her collaborators in Oslo 2 and Boston 1, and marks those documents as candidates for export to all spheres of control that belong to the same collaborative project. There are only three spheres of control in this project, Boston, Oslo, and Bangalore). If the owners of the spheres of control in Boston and Oslo choose to import some or all of Anjali's exported documents, they immediately become available for browsing (but not editing) by Alice 4, Arne 5, and Berit 6, and anyone else working in those spheres of control.

Similarly, if Bansi 8 needs access to some documents from Boston 1, he can see which documents have been exported from the Boston 1 sphere of control, who is editing each one, and the status of the documents. Assuming he has the authority to import documents to the Bangalore sphere of control residing on the Bangalore server 3, Bansi chooses the ones he needs and can then browse them.

If more fine-grained control is needed, if, e.g., Anjali would like to give Bob 9 (a colleague of Alice in Boston) and Berit 6, but no one else, access to the documents in the Bangalore sphere of control, rather than exporting any documents, she could then invite Bob and Berit as read-only participants in the Bangalore sphere. If Anjali would like to share her documents with someone, but Bansi is not yet ready to share his documents with anyone outside of Bangalore, Anjali can create a sub-sphere just for her own documents, and then export them, or invite read-only participants to her sub-sphere.

Thus, according to the present invention, even a sophisticated implementation in a complex environment will be easy to use, and will have an easy to use user interface. This is so because no one person has to keep track of all the dependencies that are established between spheres, resources, and users. It is sufficient to focus only on those spheres of control with which one is personally involved. On the other hand, users who need control and a total overview can have this through their user interface.

The point of collaborating in the first place is to have multiple people contribute towards a common goal. Thus, a collaborative system needs mechanisms for dividing up work among the participants. As described above, spheres of control help accomplish just that, and concurrency control in a sphere of control ensure that its resources are divided among the participants in that their access to those resources is properly coordinated. However, these two aspects of a system operating in accordance with the present invention have limited application. A natural style of collaboration will use more flexible mechanisms for division of work.

Considering once more the situation in which Anjali and Bansi work in the Bangalore sphere of control where the participants in that sphere have divided the documents in that sphere among themselves. Anjali is editing some documents, Bansi some others, and perhaps there are other people in Bangalore working concurrently with them in that sphere of control. The concurrency control in the Bangalore sphere of control eliminates the possibility of two or more people accidentally working on the same sub-document simultaneously.

There is, however, a further need for more dynamic mechanisms for division of work among the collaborators. If, for example, Bansi needs to make some modifications to a document currently edited by Anjali, it is undesirable for her to have to terminate her transaction so that he can get access. Such a brute force method would of course work, but it would not be a very elegant or practical solution. It would, for instance, force Anjali to give up transactional control over a document, the contents of which she is responsible for, giving her no control over what kinds of changes Bansi makes to it. The present invention offers a much better solution, by allowing Anjali to create immediately a sub-sphere for Bansi's work. While Bansi is working in Anjali's sub-sphere, she can continue working on any other document she is responsible for. When Bansi is done, he will have to commit his work to Anjali's sub-sphere, allowing her to review his changes before accepting them. This process also gives Anjali a guarantee that the document will indeed be passed back to her in due time.

The power of the present invention becomes even clearer when people originally working in different spheres of control want to collaborate. Assuming that Berit 6 in Oslo 2 discovers that she needs a contribution to one of her documents on a particular topic on which Anjali 7 in Bangalore 3 is an expert. One possible solution would be to invite Anjali 7 as a participant in the Oslo sphere of control, but that would potentially give Anjali 7 access to more documents than is perhaps desirable. Also, this solution would force Berit 6 to give up transactional control over her document, depriving her of the possibility of reviewing any and all changes before accepting them into her documents. However, the method of the present invention allows Berit 6 to create a sub-sphere for Anjali 7. This sub-sphere can then be copied to the server 3 in Bangalore and executed there, or it can remain on the Oslo server 2, and Anjali 7 can work remotely within Berit's sub-sphere in Oslo. In either case, Berit 6 will be able to review Anjali's contribution before accepting it.

As described above, the present invention enables the division of work among participants to be recursive. The system of the present invention also provides, inter alia, elegant and useful support for the sharing of information, geographical distribution of work, division of work, and delegation of work. In the last example, Berit created a sub-sphere that enabled Anjali to make a contribution to Berit's document. In the general case, any sphere of control can have any number of sub-spheres, each one of which can again have any number of sub-spheres, etc.

The present invention thus creates attractive practical implications for people working in a collaborative project. Not only can a project leader create a suitable number of spheres of control distributed over a network of servers, and not only will spheres of control help in ensuring that the right people get the right kind of access privileges to the right resources at the right times, spheres of control also support repeated and dynamic delegation of work through an arbitrary number of levels. The latter is made possible by recursion.

Suppose, e.g., that Alice, Bob, and other team members are working in the Boston sphere of control, and Bob has been assigned the responsibility for the contents of three chapters having to do with legal issues. After working on those chapters for a while, Bob has a much clearer picture of what their contents will have to be and what kind of legal expertise will be required to complete the work. He therefore decides to delegate responsibility for selected portions of the work to Peter, Paul, and Mary. After some time, Paul realizes a subsection, for which he does not have the necessary expertise, must be added to one of his documents. After a few phone calls, he finds that Tim is both capable and willing to make the desired contribution. Paul then creates a sub-sphere just for Tim, and delegates to it the subsection in question.

Bob could be totally unaware of this delegation from Paul to Tim. Bob just knows that Paul is responsible for a certain portion of the work, and that the system will ensure that Paul eventually commits his work to Bob. Alternatively, if Paul's performance is inadequate, the system will allow Bob to abort Paul's work. Similarly, when Paul delegates to Tim, Paul need not concern himself with whether Tim actually does the work himself, or delegates (part of it) to someone else.

If the creator of the original sphere of control, or the creator of any sub-sphere, wants to have tight control over how much delegation goes on in the system, a preferred embodiment of the invention includes various control mechanisms. For example, one alternative is to specify that a given sphere of control cannot have sub-spheres at all. Another alternative is to specify that only certain people are allowed to create sub-spheres. Further alternatives include a specification of a limit to the number of levels of sub-spheres that a given sphere of control can have, or that the system as a whole can have.

The glossary of Gray & Reuter 1993, page 1035, defines a “savepoint” as: “[a] named point in the execution of a transaction. In case of failure, the transaction may roll back to one of these savepoints and reestablish the transaction state as of that point. Savepoints may be persistent.” The meaning of the term “persistent” in this context is that the contents of the savepoint is permanently stored, and will not be lost even if the system is shut down or crashes.

Persistent savepoints are a prerequisite in any system that supports transactions that last for more than a few minutes. Thus, a preferred embodiment of the present invention supports persistent savepoints. This ensures that a minimal amount of work will be lost in the case of failure, and allows users to go back to the state of the system as of some earlier point in time. Thus, the latter approach is somewhat similar to versions, which can be used to track the history of a data resource.

It follows from the above that spheres of control form hierarchies (also known as tree structures), and that these hierarchies can be arbitrarily large both in terms of breadth and depth. In such a hierarchy, a given person can be the creator of, as well as participant in, any number of spheres. The resulting web of interactions and relationships between spheres of control, people, and data resources can be quite overwhelming for a human being, not because a collaborative system in accordance with the present invention is unnecessarily complicated, but because the way people prefer to perform collaborative work will in some cases be inherently complex.

The more complicated a collaborative project becomes, the more important it is that the project leader and participants have easy access to information. A lock manager component used in conjunction with the collaborative system, such as the one described in the above referenced in the '784 application (the entire contents of which have been incorporated herein by reference) constantly keeps track of the kind of information discussed here, and can at any time provide answers to a multitude of questions, for example:

Who is currently active in the Bangalore sphere of control?

Who is currently browsing (but not editing) documents in the Oslo sphere of control?

What documents are currently available for browsing or editing in the Boston sphere of control?

Who is the creator/owner of the Bangalore sphere of control?

Which spheres of control (“xymphonies”) does Anjali currently own?

In which xymphonies is Anjali currently active?

In which sphere of control is a given document currently editable?

Who is currently editing a given document?

What is the current status, quality, reliability, or degree of completeness of a given document?

What percentage of the documents in the Oslo sphere of control are still labeled as incomplete drafts?

For each document in the Oslo sphere of control not yet approved by the project manager, retrieve the name of the person currently editing that document as well as its status.

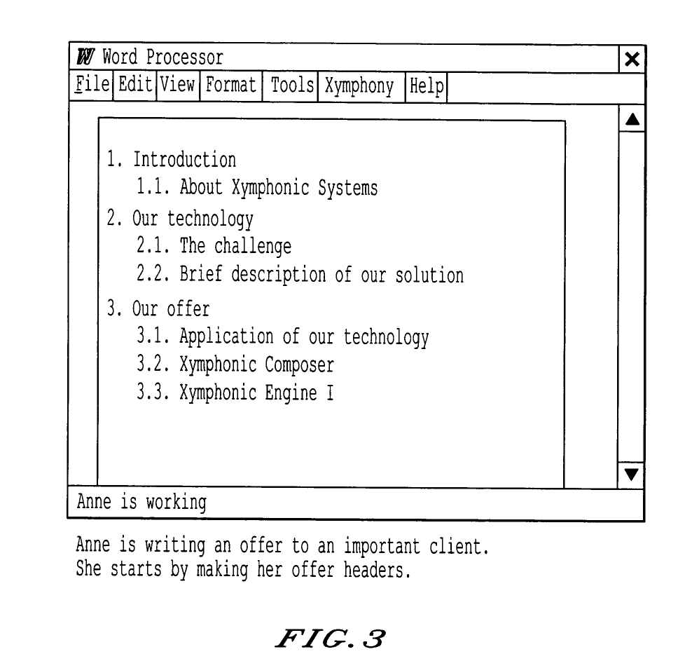

Reference is made to FIGS. 3-15, which show a number of screenshots from a client computer from which a collaboration project on a data resource is created. The data resource shown in the example of the figures is a word processing document.

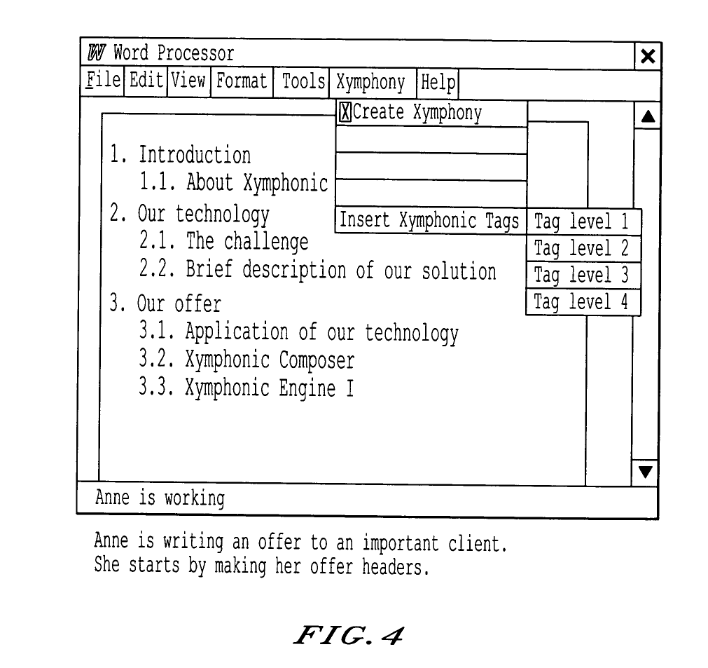

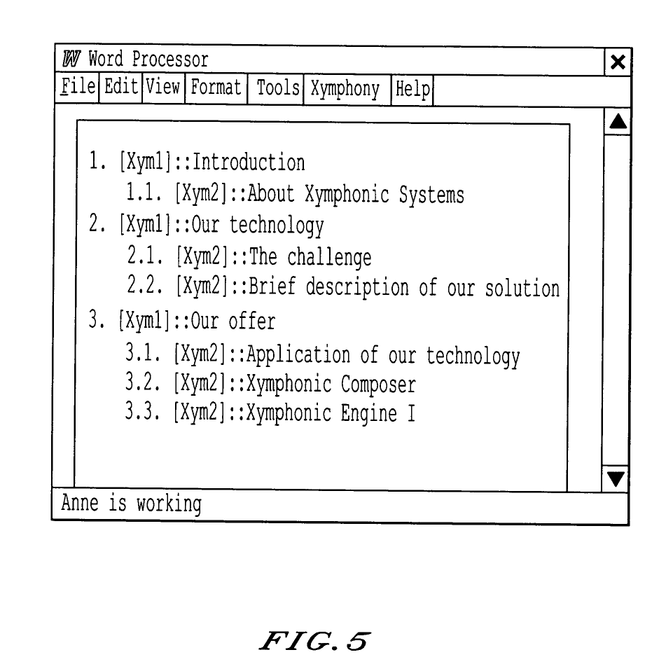

FIG. 3 shows Anne's computer screen, where she is working on an offer to an important client in her word processor. She starts by making document hearders. In this specific example, the subdivision of the data resource is achieved by the insertion of tags, e.g., [Xym1], [Xym2], etc. FIG. 4 shows how tags are inserted in this case by using menus and a pointing device such as a mouse. According to this example the implementation of this aspect of the invention is integrated into the word processor. This allows Anne to start collaborative work directly from her word processor. In this case Anne inserts level 1 tags on the header level 1 and level 2 tags on header level 2. The resulting document is shown in FIG. 5.

Alternatives other than the use of tags for subdivision are of course possible within the scope of the invention, including tags or marks that are native to the application and file format being worked on, and external references to particular parts of a file, parts of a database, or a particular memory location where the relevant data resource is located. The shared data resource may also be a number of files, in which case the subdivisions may be individual, complete files. Of course, any combination of these alternatives is possible within the scope of the present invention, and are design options that are available during the design of a system according to the present invention. In order to preserve generality, the term subdivision is intended to include the special case where the original resource is not divided into several subdivisions, i.e., where the entire resource is its own subdivision.

Examples of collaborations in which the shared resource includes various types of files or documents are a data programming project including source code files, compiled executable files, text documents and image files for documentation, etc. Another example is a construction project in which the shared resources include architect drawings, text documents, a database including information on contracts, standards, persons and roles, companies, and public offices.

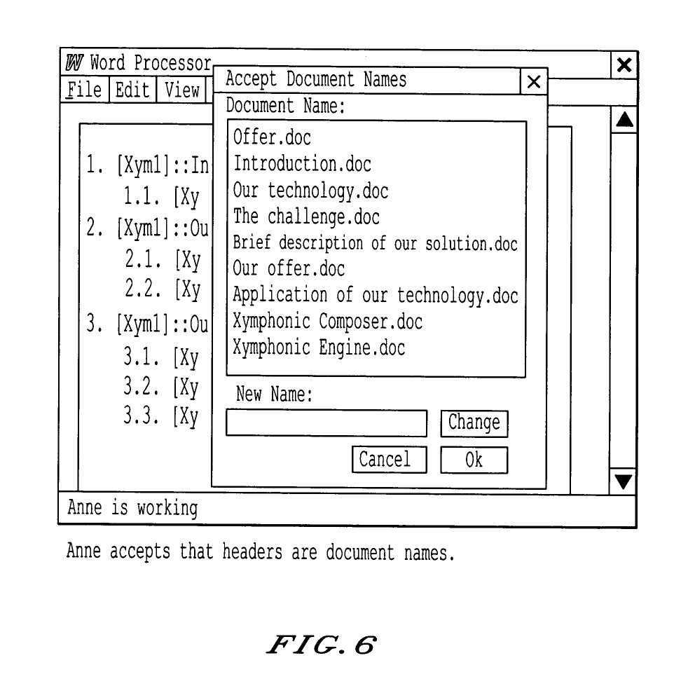

Returning to the example illustrated in the drawings, Anne will now log in to the xymphonic system and start the process of creating a xymphony. A xymphony corresponds to the aforementioned sphere of control that is created to make sub-resources available. The system operating according to the invention (hereinafter referred to as the xymphonic system) presents Anne with the user interface shown in FIG. 6. A number of sub-documents are created, each corresponding to a subdivision of the original document. Anne has the opportunity to change the names of each sub-document before she accepts the creation of the documents. The xymphony is then split into different and unique files, but the xymphonic system keeps track of the structure between all the documents.

It should be noted that even though in this example the sub-resources are individual files containing a copy of any data existing in the corresponding sub-division in the original resource, this does not have to be the case. Any implementation in which work on the sub-resource is being performed with the original data according to locks and access rules is entirely within the scope of the present invention.

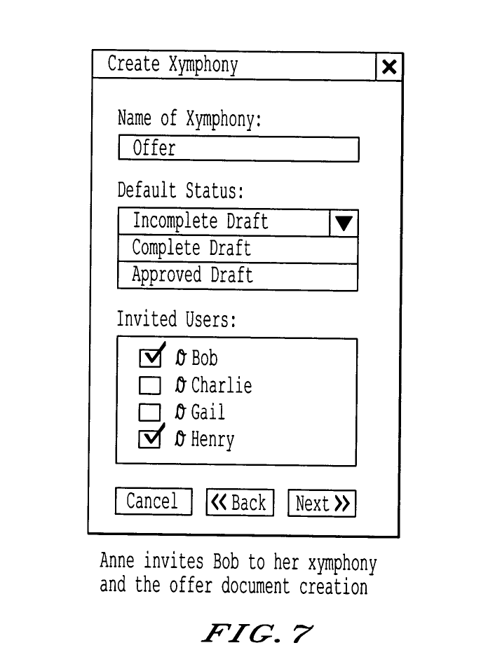

FIG. 7 illustrates how additional participants in a collaboration working on other computers may be invited into the xymphony. In this case Bob is invited, as indicated by the check mark next to his name. In this dialog window the name of the xymphony and the default status of documents are also shown and may be changed.

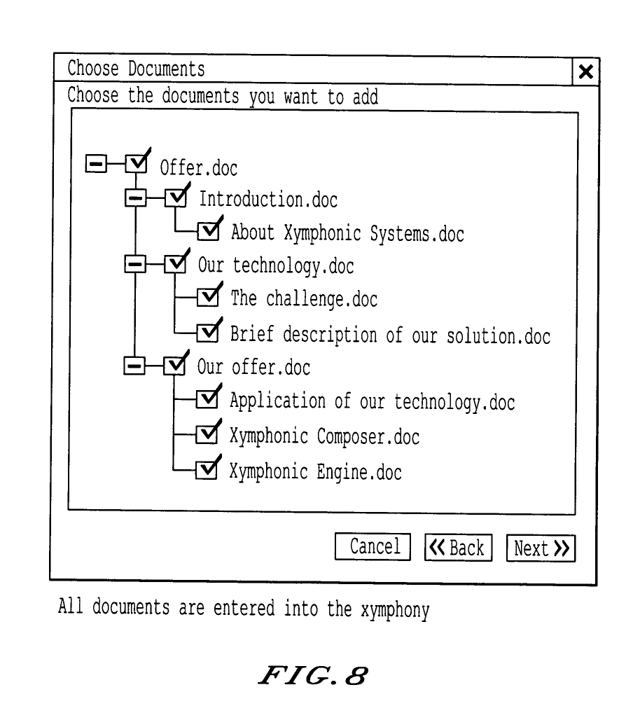

FIG. 8 shows that in this case Anne has chosen to include all the created sub-documents in the xymphony. She could, of course, have chosen to exclude one or more documents.

Next, Anne must decide who has responsibility for the respective documents, and this is done by assigning documents to users as shown in FIG. 9. Anne marks some documents and chooses herself as the responsible editor. The remaining documents are assigned to Bob. The xymphony is created and Anne and Bob may start working on the “Offer” document.

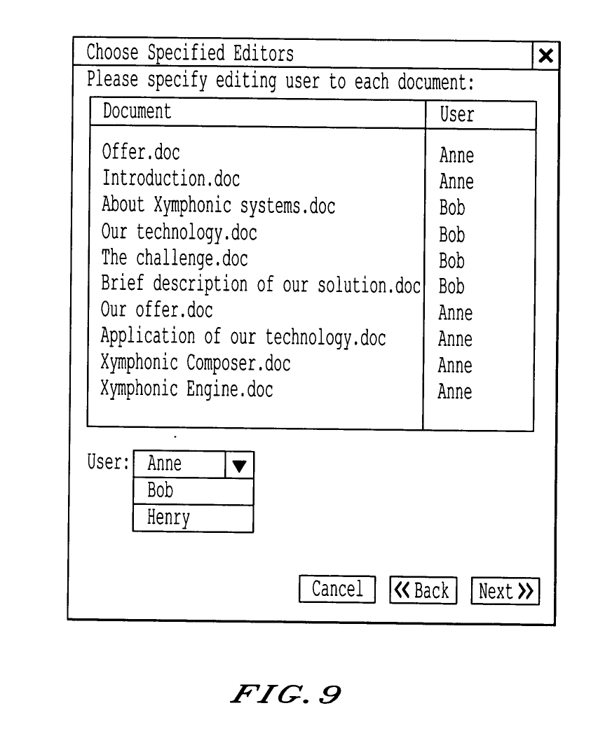

FIG. 10 illustrates a view of documents residing on the server of the xymphonic system as well as on Anne's computer. For the documents in which Anne has write access (symbolized by a pencil), Bob has read-only access (symbolized by glasses), and vice versa. Among the information shown in the hierarchy on the server is the name of the xymphony manager, in this case Anne, the documents in the xymphony, and the fact that Anne as a participant has read-only rights on some documents and edit rights on others.

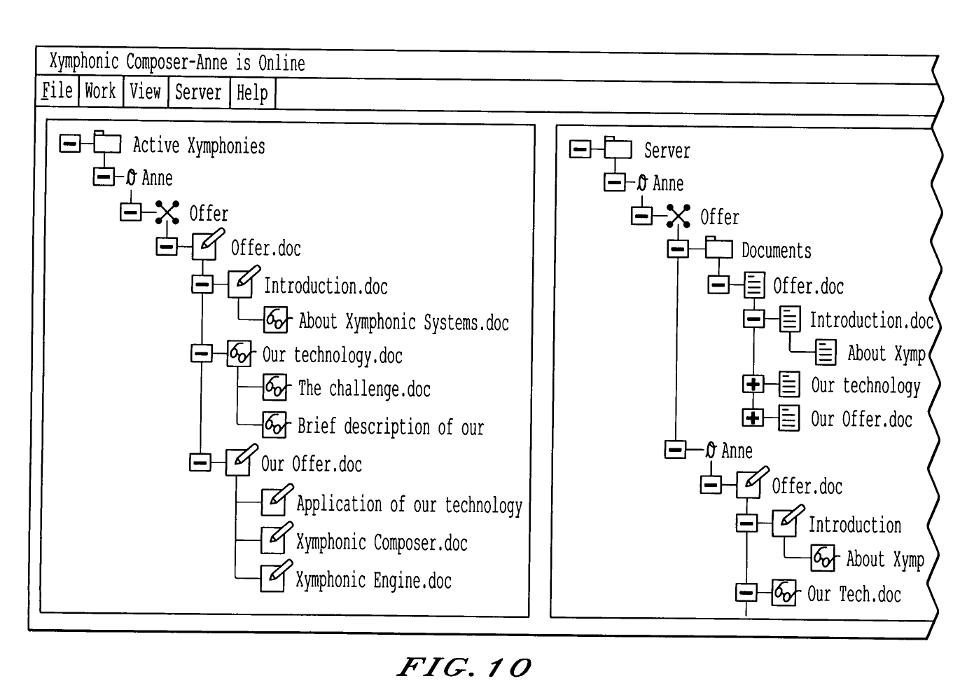

As soon as Bob is made aware that he is invited to the xymphony he may register his participation and access the subdivisions of the shared data resource he is assigned, in this case sub-documents that correspond to parts of the main document. He opens the xymphony client and logs on to the system. As shown in FIG. 11, Bob sees active xymphonies on the server, and when he starts working in the xymphony, he gets a similar view on his desktop as Anne, but with his own access rights shown. Also, at this point in the collaboration, Bob is shown in the server view as an active participant in the xymphony.

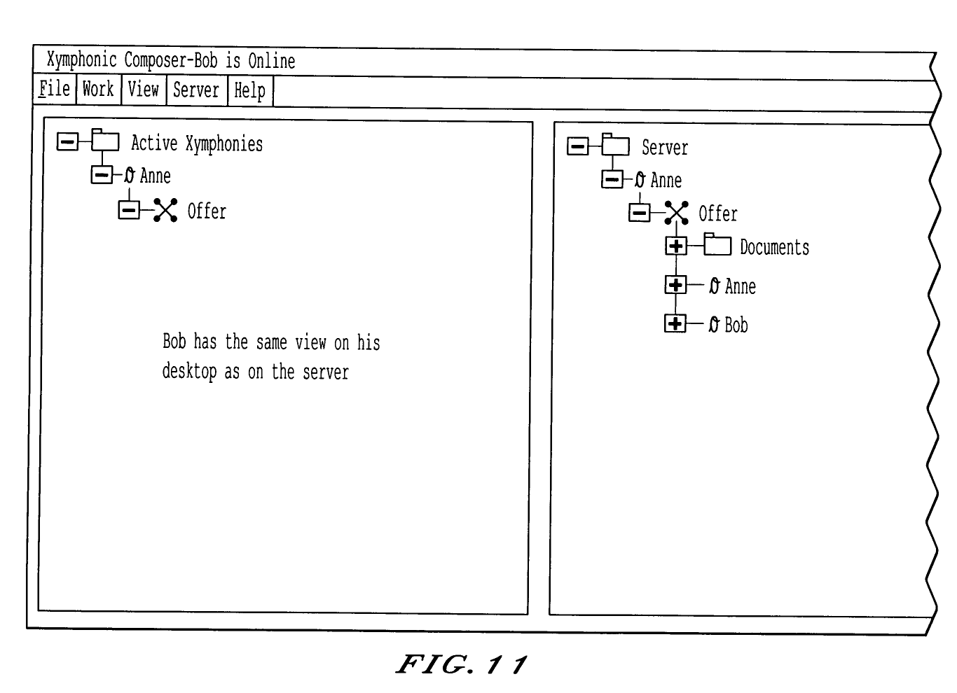

FIG. 12 shows an expanded view of the hierarchy from which Bob can choose a sub-document and start editing it.

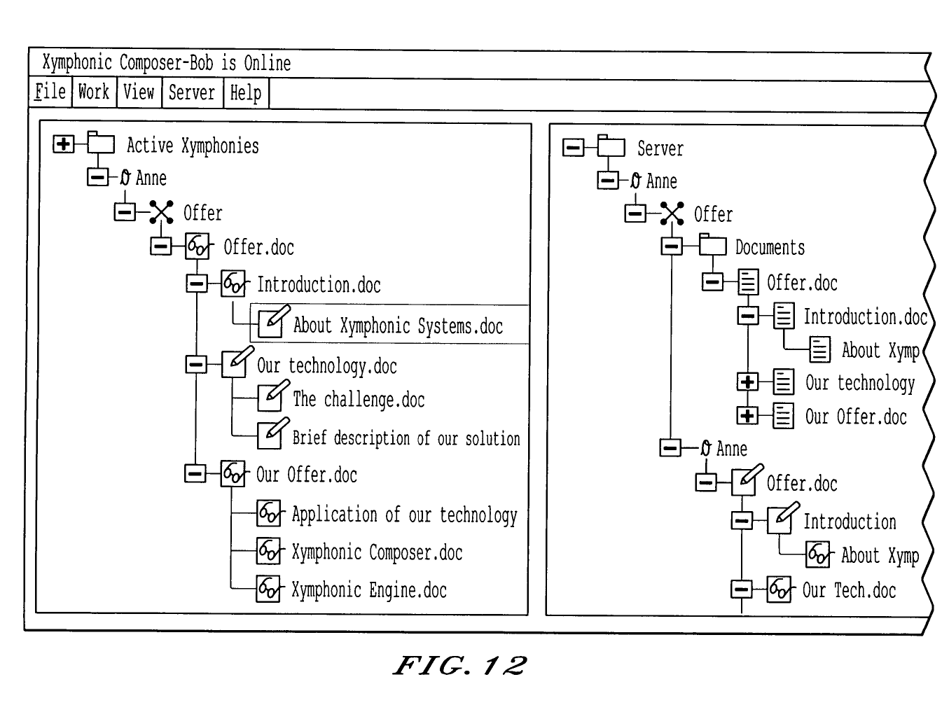

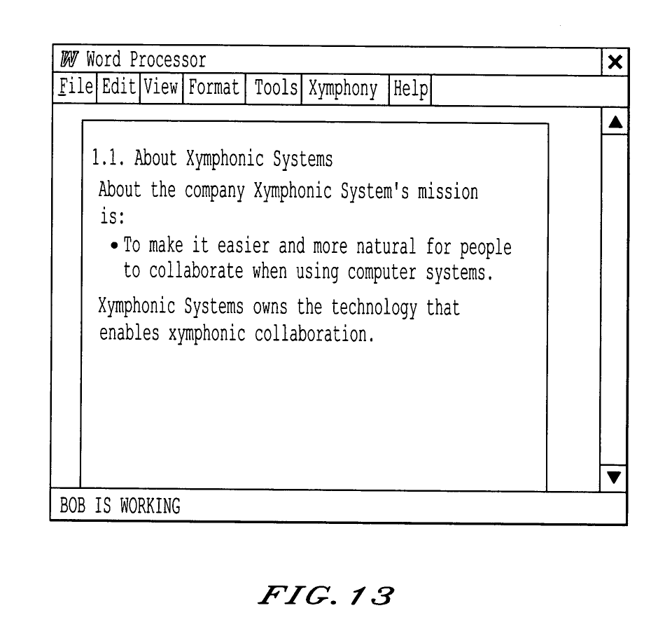

FIG. 13 shows a sub-document accessed from the xymphonic client and opened in Bob's word processor. He may now write his chapter and store his work on the server. After he is finished he notifies Anne. Anne may now review Bob's work by opening the document from the xymphonic client on her computer. FIG. 14 shows the document with Bob's contribution indicated. If Anne is satisfied, she accepts and Bob's contribution is committed.

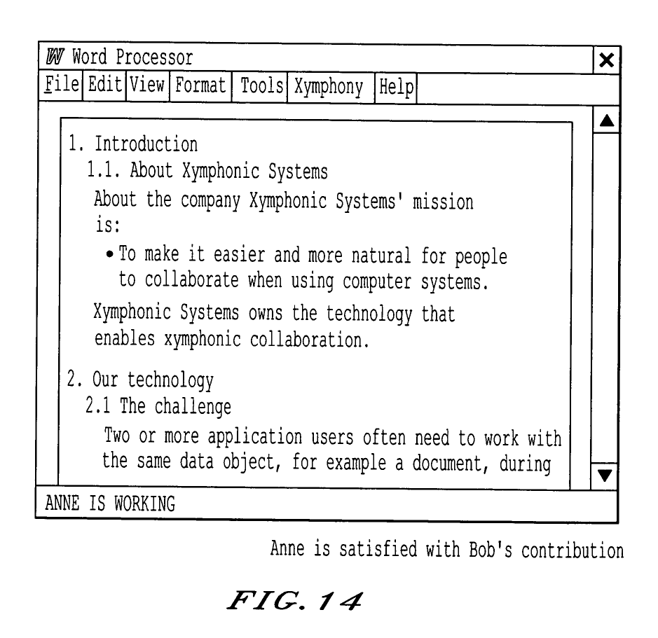

FIG. 15 shows the finished document after Bob's contribution has been committed and Anne has written a short introduction.

From the above, it will be understood that it is possible from the client computer to create a sphere of control (referred to as a xymphony), create or include a pre-created data resource, such as one or more document, and create sub-resources, such as sub-documents. Also, from the client computer it is preferably possible to set a limit on the number of generations of sub-documents that can be created. Several implementation options are available for this feature. One alternative is to register the limitations in a central database that administers the shared resources and handles locks, e.g., in accordance with the database system described in the aforementioned '784 patent application. Alternatively, the number of levels could be incorporated in the shared resources themselves e.g. as a limitation in the allowable tags used for subdividing the resource.

Furthermore, according to a preferred embodiment of the invention, a client computer working in accordance with the invention is able to make shared resources available from other spheres of control. This is done either by allowing external access, or by exporting the resource to a different sphere of control. Exporting a resource means that it will be checked out, and hence locked, until it is returned.

Documents are assigned to participants in the relevant sphere of control, write access is then only given to the person to whom the sub-document is assigned. This is done by placing locks in the database. See the above-mentioned '784 application. The client can search the database and display a tree structure representing the documents in the sphere of control, the members, and the status for each document with respect to each user. Further, the client can join the sphere of control, import a tree structure representing the documents in the sphere, giving the participant the chance to open the documents to which he has access. The participant working on a document can change the status of the document. The owner of the sphere can check the status of any document and approve the sub-document to be imported back into the parent document. The sub-document will then be locked.

FIGS. 3-15 illustrate the hierarchical structure of the documents in a sphere of control. All the sub-documents are treated as transactions relative to the document they have descended directly from. This means that the parent resource, or at least the relevant subdivision of the parent resource, will be locked while the transaction is alive (i.e., until the sub-document is committed). According to a preferred embodiment of the present invention, this locking will be handled by a database system described in the '784 application.

In the same manner, a sub-sphere can be created. A sub-sphere is at least some of the resources of a given sphere of control copied or delegated into a new sphere of control. This sub-sphere will be an open transaction in the original sphere of control, and consequently, all the resources that have been copied or delegated into the sub-sphere are locked in the sphere from which they originate. When a sub-sphere is committed, all changes that were made in the resources in the sub-sphere being committed will be copied or delegated into the original resources in the correct places, unless they are not accepted by the owner of that particular resource in the original sphere or whoever has authority to accept or reject transactions being committed.

The various resources, such as documents, subsections of documents, files etc., will normally have one or more access parameters associated with them. In FIGS. 3-15, this is illustrated as documents having a status: Incomplete Draft, Complete Draft, or Approved Draft. The various access parameters and the possible status for each access parameter, may vary according to the context. When the sphere of control (collaboration project) is created, all resources should be assigned a default status. In the figures, Incomplete Draft is selected as the status of all sub-documents when work on the collaborative project starts.

Normally the values of the access parameters will be stored in a database accessible by client computers working in accordance with the system of the present invention. Thus, it is possible for a participant to search for and access, subject to locks and restrictions, shared resources that fulfill particular criteria, as has already been described in the above examples with reference to FIG. 1.

The status of a resource will normally be changed, e.g., when a person finishes working on it, when it is committed to the parent resource, and when it undergoes various forms of approval. As described above, a particular resource, such as a document, may include tags containing information directly related to the functionality of the collaboration, such as the subdivision of the resource. It is also possible to include other meta information in the documents, files, or resources themselves. According to a preferred embodiment, however, the amount of meta information included in the resources themselves is limited. Instead, the meta information is included in the database handling the structure of the sphere of control. Access to the various resources and sub-resources will be dependent on access information, locks, etc. stored in this database.

Further, there will be an “uppermost” set of resources representing the resources that were created when the original sphere of control was created. In the illustrated example shown in FIGS. 3-15, this is the top-level document called Offer.doc. All other documents represent transactions that are to be committed back to this top-level document. Whether a particular document can be read and/or changed by a particular participant depends on the meta information stored in the database. In the example of FIGS. 3-15, this is illustrated as documents that are locked or can be modified from the point of view of the various users.

As shown in FIGS. 3-15, Anne is able to write to the document called Introduction.doc, but not to the document called AboutXymphonicSystems.doc, which is a sub-document of Introduction.doc. This means that AboutXymphonicSystems.doc is a live transaction in Introduction.doc, and Anne will not be able to modify the part of Introduction.doc that is represented by AboutXymphonicSystems.doc, since this document is assigned to Bob. In this case, there is no part of Introduction.doc that is actually locked, but when Bob's contribution is committed, his document will be inserted in the parent document as an entire section representing that part of the document.

If a sub-sphere is created, a new database is created. This database will represent a transaction in the parent database, and in this manner nested databases are created. Nested databases are described in more detail in the documents incorporated herein by reference.

When sub-resources or sub-spheres are created, the resources are copied or delegated, but the way this copying or delegation is tracked by meta information and supplemented by locks, makes it impossible for several copies of the same data to be modified at the same time. Resources may be copied and progress through the hierarchical structure of sub-resources, but if it is desired that two people work on the same resource at the same time, the resource will be sub-divided, and each person can work only on his or her subdivision. When the work is finished, changes progress back through the hierarchical structure the same way they were assigned, and will eventually be committed to the original top-level resource, unless it is aborted at some time.

A client application upon a client computer working in a sphere of control is able to access the database in order to access shared resources and meta information about the shared resources. In FIGS. 3-15, an illustration of how Bob accesses this information and brings up a view of active spheres of control on the server, registers as a participant, and accesses document assigned to him is shown.

In addition to being able to access and handle the various meta information about the resources, a client application is able to access the resources themselves, modify them, and import modifications made elsewhere when the resource is being approved to be committed. However, it should be noted that this functionality could be divided between several applications, or even several computers, such as one workstation for demanding CAD work, and one personal computer for accessing and retrieving meta information and fetching files, etc.

In the above description of the preferred embodiment, a central computer has been described as containing one or more databases and a database management system, e.g., the database management system described in the incorporated references. It should, however, be noted that a more distributed solution is possible. All meta information could be, e.g., incorporated in the various documents or data resources, with a reference to the transaction controlling said resources, or meta information could be stored in a partial database on the client computer upon which it is created. This information would then include information on where a resource was fetched from and where it has been sent to. The progress of a resource through the network is then tracked in a distributed fashion in the network, and the recursive searching is made through the network in order to gather the desired information. Documents can then be distributed on a peer-to-peer basis between the client computers.

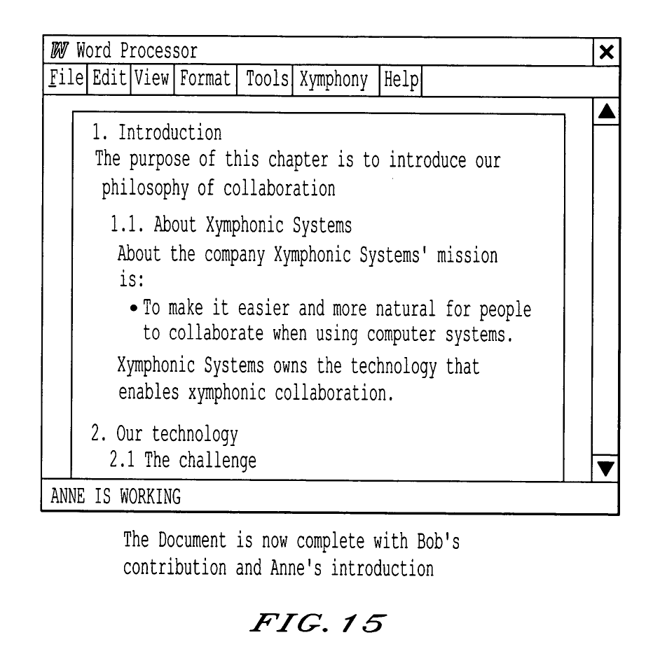

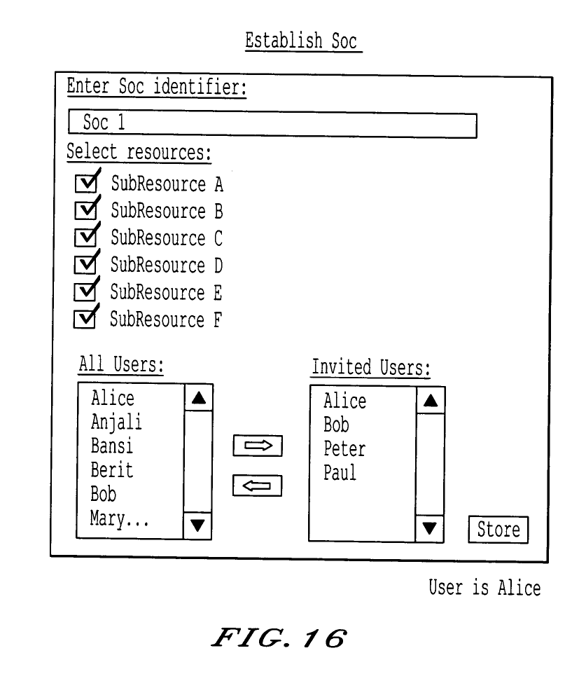

A further example of the method of the present invention is illustrated in FIGS. 16-23, without reference to word processing or any other particular application. In FIG. 16, a user Alice creates a sphere of control (SOC1), selects the sub-resources associated with SOC1 and invites subusers to join her xymphony. Next, as shown in FIG. 17, Alice determines which sub-users will access which sub-resources, and with which associated access rights (e.g., Read/Write, Read-only, or No Access). Note that Peter has been invited in to SOC1 and has been given Read/Write access to Sub-resources C, D, and E.

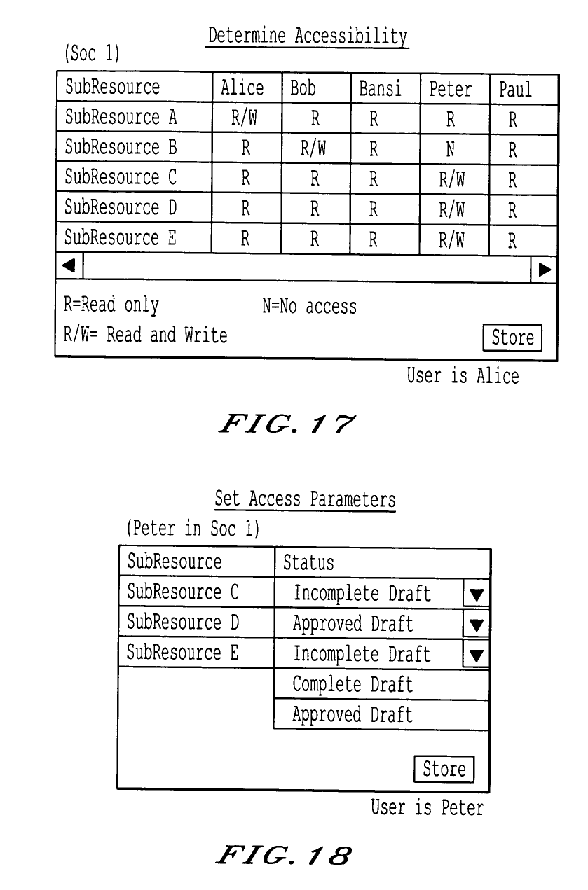

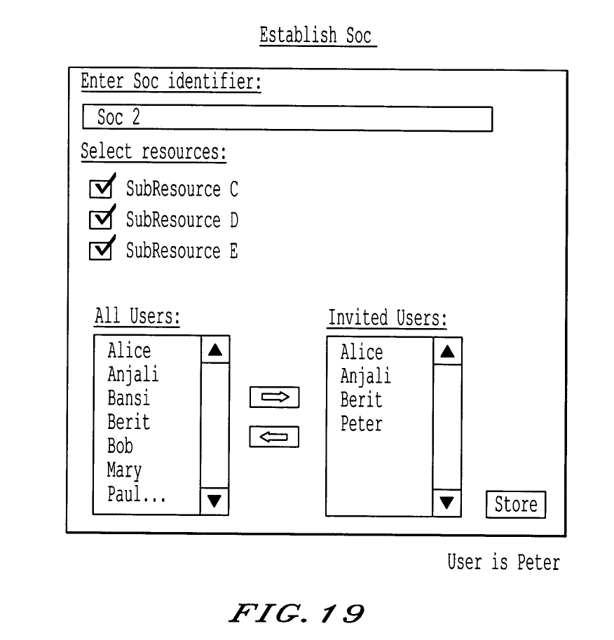

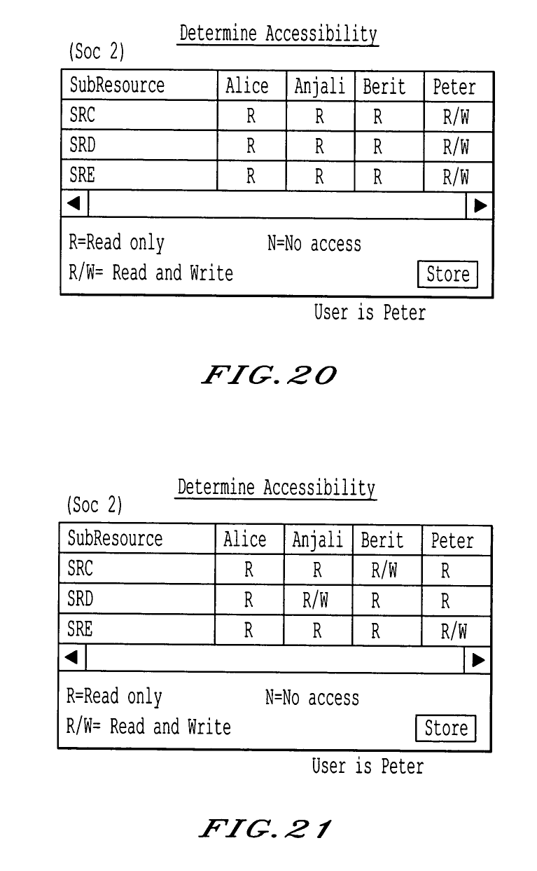

As shown in FIG. 18, Peter then determines the status of the sub-resources to which he has edit rights. Moreover, as shown in FIG. 19, Peter may create his own sphere of control (SOC2) which is a sub-sphere of control of SOC1. Of course, Peter can only delegate sub-resources to which he has edit rights. Thus, as shown in FIG. 20, Peter has Read/Write access rights to all of the sub-resources in SOC2. Peter may then give the other invited users, e.g., Berit, Read/Write access to various sub-resources, which turns his corresponding access rights to Read-Only, as shown in FIG. 21.

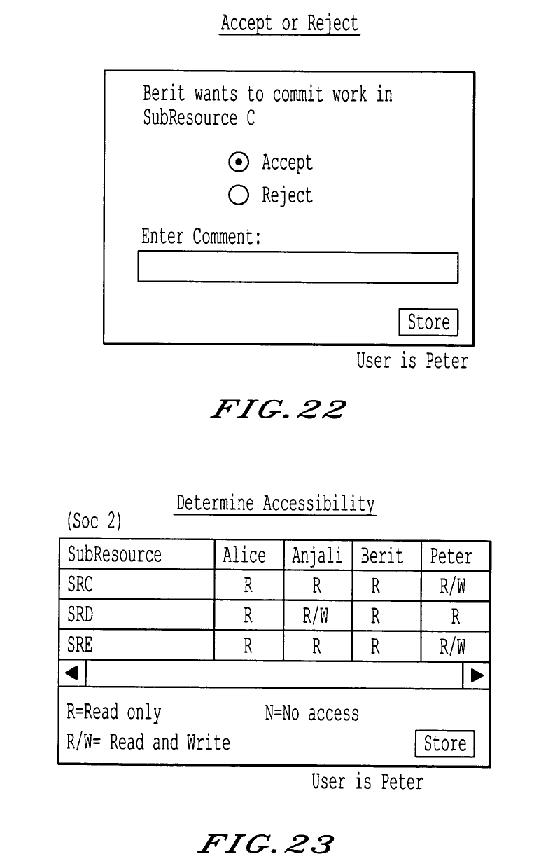

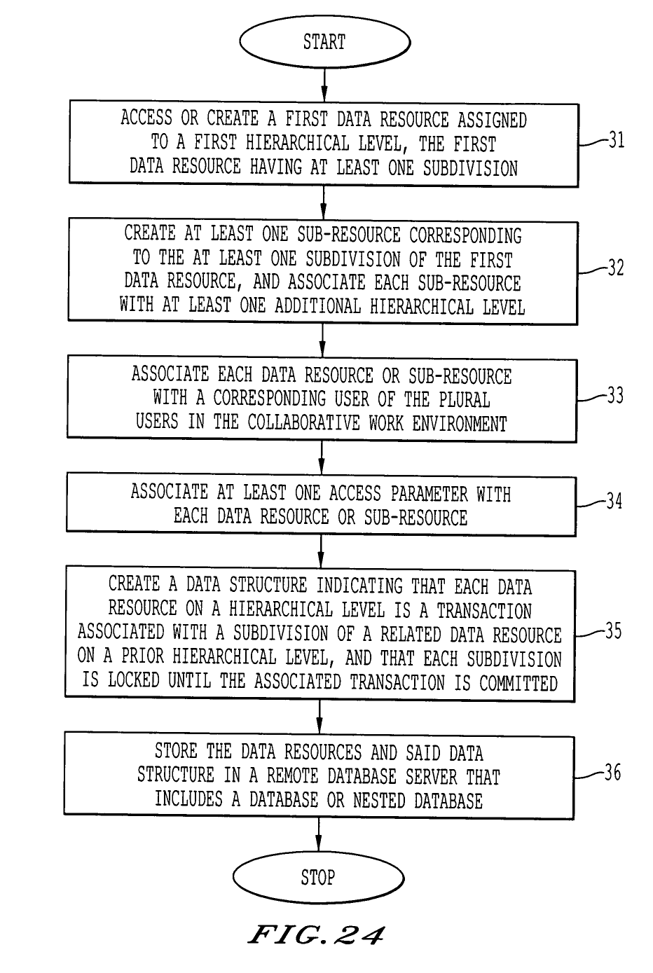

In FIG. 22, Berit has completed her work and Peter decides whether to accept or reject her work. After accepting the work, Peter restores Read/Write access rights to the resource, as shown in FIG. 23.

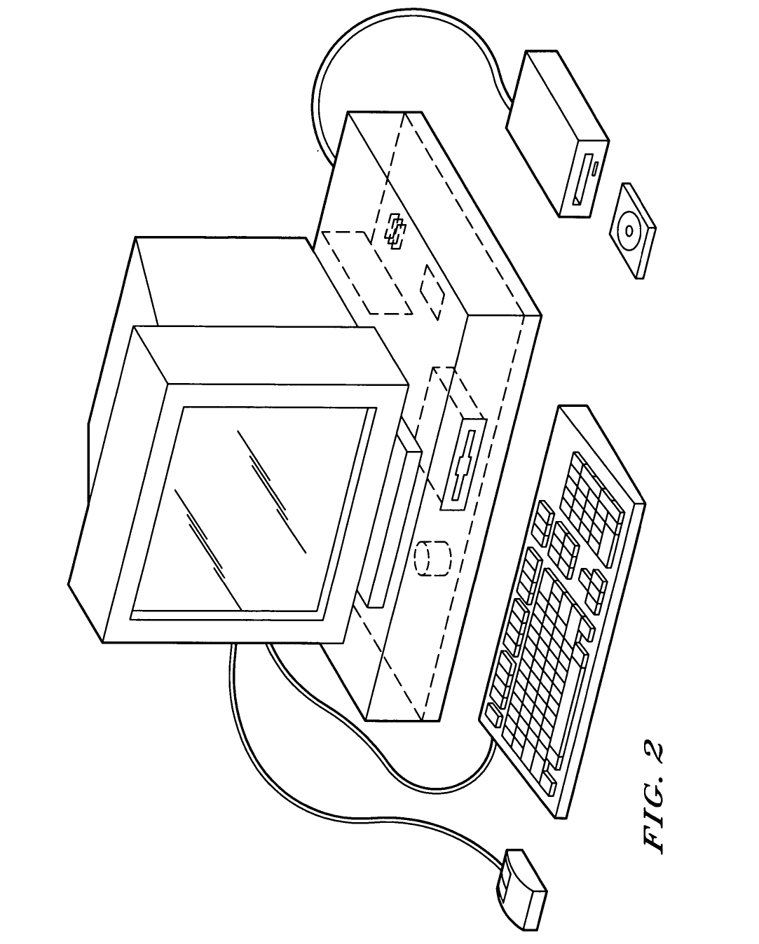

FIG. 2 is a schematic illustration of a general purpose computer that can be programmed according to the teachings of the present invention. The computer can be used to implement the processes of the present invention, wherein the computer includes, for example, a display device (e.g., a touch screen monitor with a touch-screen interface, etc.), a keyboard, a pointing device, a mouse pad or digitizing pad, a hard disk, or other fixed, high density media drives, connected using an appropriate device bus (e.g., a SCSI bus, an Enhanced IDE bus, an Ultra DMA bus, a PCI bus, etc.), a floppy drive, a tape or CD ROM drive with tape or CD media, or other removable media devices, such as magneto-optical media, etc., and a mother board. The mother board includes, for example, a processor, a RAM, and a ROM (e.g., DRAM, ROM, EPROM, EEPROM, SRAM, SDRAM, and Flash RAM, etc.), I/O ports which may be used to couple to an image acquisition device and optional special purpose logic devices (e.g., ASICs, etc.) or configurable logic devices (e.g., GAL and re-programmable FPGA) for performing specialized hardware/software functions, such as sound processing, image processing, signal processing, neural network processing, automated classification, etc., a microphone, and a speaker or speakers.

As stated above, the system of the present invention includes at least one computer readable medium. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools. Such computer readable media further includes the computer program product of the present invention for performing any of the processes according to the present invention, described above. The computer code devices of the present invention can be any interpreted or executable code mechanism, including but not limited to scripts, interpreters, dynamic link libraries, Java classes, and complete executable programs, etc.

Accordingly, the mechanisms and processes set forth in the present description may be implemented using a conventional general purpose microprocessor or computer programmed according to the teachings in the present specification, as will be appreciated by those skilled in the relevant art(s). Appropriate software coding can readily be prepared by skilled programmers based on the teachings of the present disclosure, as will also be apparent to those skilled in the relevant art(s). However, as will be readily apparent to those skilled in the art, the present invention also may be implemented by the preparation of application-specific integrated circuits or by interconnecting an appropriate network of conventional component circuits.

The present invention thus also includes a computer-based product which may be hosted on a storage medium and include instructions which can be used to program a general purpose microprocessor or computer to perform processes in accordance with the present invention. This storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, numerous modifications and variations of the present invention are possible in light of the above teachings. It is therefore to be understood that within the scope of the appended claims, the invention may be practiced otherwise than as specifically described herein.

1. A method for managing a collaborative work environment wherein plural users share data resources, comprising:
accessing a first data resource assigned to a first hierarchical level, the first data resource having at least one subdivision;
creating at least one sub-resource corresponding to said at least one subdivision of the first data resource, and associating each sub-resource with at least one additional hierarchical level; and
creating a data structure indicating that each data resource on a hierarchical level is associated with a transaction that is associated with a subdivision of a related data resource on a prior hierarchical level, and that each subdivision is locked until the associated transaction is committed.

2. The method of claim 1, wherein the accessing step comprises:
creating the first data resource having at least one subdivision.

3. The method of claim 1, further comprising:
associating each data resource or sub-resource with a corresponding user of said plural users in said collaborative work environment.

4. The method of claim 1, further comprising:
associating at least one access parameter with each data resource or sub-resource.

5. The method of claim 4, wherein said at least one access parameter represents at least one of work status, approval status, ownership, whether the data resource or the sub-resource is locked, and by which transaction the data resource or sub-resource is locked.

6. The method of claim 1, further comprising:
storing the data resources and said data structure in a remote database server that includes a database or nested databases.

7. The method of claim 1, further comprising:
storing the data resources and said data structure in a distributed manner in a data network.

8. The method of claim 3, further comprising:
assigning a selected sub-resource corresponding to a further sub-division of an existing sub-resource;
associating said sub-division with a selected user in said collaborative work environment; and
placing a lock on said sub-division of said existing sub-resource until the assigned sub-resource is committed, approved, and included in the original sub-resource.

9. The method of claim 1, wherein each data resource or sub-resource is an electronic document, a computer file, a set of computer files, or a computer resource that can be accessed, copied, and modified from a client computer.

10. A method for accessing, from a client computer, a shared data resource in an environment for collaborative work, comprising:
retrieving a data structure stored on a computer network, said data structure representing said data resource and sub-resources associated with at least one sub-division of said data resource,
said sub-resources being associated with at least one hierarchical level, each data resource on a hierarchical level being associated with a transaction that is associated with a subdivision of a data resource on a prior hierarchical level, and each subdivision being locked until all associated transactions are committed.

11. The method according to claim 10, further comprising:
modifying an accessed sub-resource and returning the modified sub-resource to the computer network with an updated access parameter indicating that the modified sub-resource is pending reintroduction into the corresponding data resource.

12. The method according to claim 10, further comprising:
representing, on a display of said client computer, a graphical representation of said data resource and sub-resources arranged according to said at least one hierarchical level.

13. The method according to claim 11, wherein said data structure includes access parameters indicating at least one of work status, approval status, ownership, whether the data resource is locked, and by which transaction the data resource is locked.

14. The method of claim 13, further comprising:
associating said data resource and sub-resources with at least one access parameter.

15. The method according to claim 10, wherein said data structure is modified, as a result of a request, to only include representations of resources and sub-resources that fulfill a set of conditions regarding access parameters associated with each resource and sub-resource.

16. The method according to claim 10, wherein said data resource and said data structure are stored in a remote database server having a database or nested databases.

17. The method according to claim 10, wherein said data resource and said data structure are stored in a distributed manner in a data network.

18. The method according to claim 10, wherein each data resource or sub-resource is an electronic document, a computer file, a set of computer files, or a computer resource that can be accessed, copied, and modified from a client computer.

19. A computer program product storing program instructions on a computer readable media for execution on a client computer system, which, when installed on the client computer system, cause the client computer system to perform the method recited in any one of claims 1-18.

20. A system for managing a collaborative work environment in which plural users share at least one data resource, comprising:
plural client computers, each client computer having a collaborative user interface configured to allow a respective user to access or create a first data resource assigned to a first hierarchical level, the first data resource having at least one subdivision; and
at least one server computer communicatively coupled to the plural client computers over a network, the at least one server computer having a database management system configured to create at least one sub-resource corresponding to the at least one subdivision of the first data resource, and associating each sub-resource with at least one additional hierarchical level,
wherein the database management system is configured to create a data structure indicating that each data resource on a hierarchical level is a transaction associated with a subdivision of a related data resource on a prior hierarchical level, and that each subdivision is locked until the associated transaction is committed.

21. The system of claim 20, wherein the database management system is configured to associate each data resource or sub-resource with a corresponding user of said plural users in said collaborative work environment.

22. The method of claim 20, wherein the database management system is configured to associate at least one access parameter with each data resource or sub-resource.

23. A collaborative user interface configured to coordinate collaborative work over a network by plural users, comprising:
a first interface unit configured to allow a user to establish a sphere of control in which at least one authorized sub-user has access to at least one respective sub-resource selected from plural data resources stored in a database;
a second interface unit configured to allow the user to accept or discard work performed on the at least one sub-resource by each of the at least one authorized sub-user; and
a third interface unit configured to display a hierarchical representation of the sphere of control, including a status of the sub-resources associated with each sub-user.

24. The collaborative user interface of claim 23, wherein the first interface unit is configured to allow the user to determine the at least one authorized sub-user and to invite the at least one authorized sub-user to participate in the sphere of control.

25. The collaborative user interface of claim 23, wherein the first interface unit is configured to allow the user to determine the sub-resources accessible to each sub-user in the sphere of control.

26. The collaborative user interface of claim 23, wherein the first interface unit is configured to prevent the user from allocating greater access rights over the at least one sub-resource, to the at least one authorized sub-user, than the access rights held by the user.

27. The collaborative user interface of claim 23, wherein the first interface unit is configured to allow each of the at least one authorized sub-user to set an access parameter for an associated sub-resource in the sphere of control, the access parameter indicating a status of the associated sub-resource.

28. The collaborative user interface of claim 25, wherein the first interface unit is configured to designate a sub-resource accessible to a sub-user as read-only to the user until the work performed by the sub-user on the sub-resource is accepted or discarded by the user.

29. The collaborative user interface of claim 28, wherein the first interface unit is configured to restore to the user original access rights to the sub-resource after the work performed by the sub-user on the sub-resource is accepted or discarded by the user.

30. The collaborative user interface of claim 23, wherein the first interface unit is configured to allow the user to split an existing sub-resource into one or more sub-resources so that other of the plural users can be authorized to access the one or more sub-resources.
